(19) United States
(12) Patent Application Publication
(10) Pub. No.: US 2009/0149603 A1
(43) Pub. Date: Jun. 11, 2009

(54) SLIDING OR FRICTION ELEMENT, IN PARTICULAR FOR GUIDING POWER TRANSMISSION BELTS

(75) Inventors: Bernd Hartmann, Weisendorf (DE); Sergej Schwarz, Nurnberg (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: SCHAEFFLER KG, Herzogenaurach (DE)

(21) Appl. No.: 11/719,450

(22) PCT Filed: Oct. 18, 2005
(86) PCT No.: PCT/EP05/11159

§ 371 Date: Jun. 28, 2007

(30) Foreign Application Priority Data
Nov. 17, 2004 (DE) 102004055421.8

(51) Int. Cl. B29C 45/00; C08F 8/00

(52) U.S. Cl. 525/190; 264/240

(57) ABSTRACT

A sliding or friction element that can be mechanically stressed is provided that includes a mechanically stressed section that is formed of a combination of at least two different plastics, one of which acts as a lubricating material. The first plastic (11) forms a plastic matrix, in which the second plastic (12) is chemically bonded.

### BACKGROUND

The invention relates to a sliding or friction element, in particular for guiding power transmission means, for guiding and tensioning a power transmission means, a slide lining for pivoting bearings, a sliding bearing, a plastic cage for cylinder bearings, or plastic components for linear guides, comprising a section, which is mechanically loaded especially by a power transmission means or by a different component that can move relative to the sliding or friction element and which is comprised of at least two different chemically bonded plastics mixed together, of which one acts as a sliding material.

Such sliding or friction elements are known, e.g., in the form of slide bushings, pivoting bearings, or sliding bearings. They are also known in the form of power transmission means guides, which are used for guiding and tensioning a power transmission means such as belt or a chain integrated in a power transmission means drive. Such power transmission means drives are used, for example, in internal combustion engines. Through use of the power transmission means guide it is assured that the power transmission means always remains sufficiently tensioned when the load changes, so that the units integrated in the power transmission means drive are also reliably driven via the power transmission means.

Friction or sliding elements, e.g., in the form of sliding rails that have at one end a bearing, with which they can pivot on a third object, are known. Chain tensioners, which have two rail-like sections, are further known, which contact opposite each other and at two different chain sections. Furthermore, rollers, which are arranged on a lever arm that can pivot, in turn, on its side, are to be noted. All of the above described friction or sliding elements have the common feature that they are exposed during operation to mechanical loads of different type, which usually derive from a movement of a third object relative to the sliding or friction element or from movement of individual parts of the element relative to each other.

The sliding or friction elements usually have sections composed of a mixture of two different plastics or are produced as a whole from these plastics. The chain, for example, runs along these sections. Primarily for fixed power transmission means guides or tensioners, for example, slide rails, the static arrangement of the power transmission means guide leads to considerable stress through the chain moving relative to this guide and contacting the section while sliding. With respect to known power transmission means with good wear resistance in the region of the guide section made from several mixed plastic components, usually two different plastics are used, of which one is a filler and is used as a sliding material. Usually polyamide (PA) is used as a solidity-determining material and polytetrafluoroethylene (PTFE) is used as the sliding material. Such a sliding element or power transmission means guide in the form of a slide rail is known, e.g., from DE 201 18 901 U1.

The production of friction or sliding elements of different types, for example, power transmission means guides or sections in the form of slide rails or rollers or the like is realized preferably using plastic injection molding methods, with a granulate being used as the starting material. The granulate is formed of a prefabricated mixture of two plastic types, wherein these are mixed with each other during the granulate production as pure starting materials in nodule or pellet form and the granulate mixtures from these are compressed. The injection molded granulate is comprised of two or more portions or quantities of pure plastic types, which depend on each other due to the physical compaction in the scope of the granulate production. This means that a granulate is comprised of, for example, one half PA and the other half PTFE, with the two plastic types being bonded to each other along a sharp boundary due to the compaction during the granulate production.

From this results the problem that a homogeneous distribution of the different plastic types is not set over the molded object even after the granules are fused in the injection molding process into the final molded object, for example, the slide rail, but instead islands of increased concentration, primarily of PTFE, are formed, which are present in shortfall relative to the PA. It is further to be observed that injection molding forms an external molded skin, in which there is absolutely no sliding plastic, that is, absolutely no PTFE. This is found first in an inhomogeneous distribution underneath the surface. This inhomogeneity and the lack of sliding plastic at the surface leads to the result in newly installed power transmission means guides, for example, in newly installed slide rails, of a so-called stick-slip phenomenon. This is understood to be an interaction between static friction and sliding friction caused by the poor sliding property of the slide rails at the guide surface, namely the molded skin. Thus, the chain running over this surface is not guided homogeneously; it is not exposed to homogeneous sliding properties there. This leads to vibrations induced in the power transmission means and noises resulting from these vibrations when starting up a new power transmission means guide, with these problems persisting until the molded skin has been removed mechanically due to the chain action.

### SUMMARY

The invention is based on the objective of providing an arbitrary type of sliding or friction element, e.g., in the form of a power transmission means guide, a bearing bushing, a slide or friction coating that can be applied to a third object, or the like, which is improved relative to these types and which offers homogeneous sliding properties.

To meet this objective, for an arbitrarily constructed sliding or friction element it is provided according to the invention that the first plastic forms a plastic matrix, in which the second plastic is chemically bonded.

Different from before, for producing the sliding or friction element according to the invention, e.g., in the form of a power transmission means drive, a granulate is used, in which there is no physical bonding of the two plastic types, but instead, in which the second plastic is chemically embedded in a plastic matrix formed by the first solidity-determining plastic. Thus, there is a true chemical bond of the second plastic acting as the sliding material to the first plastic on a molecular level. This has the result that even for fusing during the injection molding process, obviously a homogeneous distribution of the plastic components is given, which is set uniformly within the molded object, that is, the plastic matrix of the first plastic also forms there, in which the second plastic is chemically bound. Seen in cross section, a homogeneous distribution of the sliding plastic in the molded object, even at the outer sides, is produced. The difficulties that are given from the inhomogeneous distribution and the formation of the molded skin in the state of the art as described above advantageously no longer appear in the object formed according to the invention. The friction or sliding element produced in this way features generally improved physical, mechanical, and tribological properties. Consequently, due to the homogeneous sliding properties at all times, stick-slip phenomenon no longer appear in the area of the system of the power transmission means, so that no difficulties are produced, e.g., when starting up a new tensioner. It is further advantageous that due to the guaranteed homogeneous distribution of the sliding plastic, less of this material is required in terms of quantity compared with the state of the art, where significantly more must be used in the processing in order to compensate for concentration fluctuations produced from the island formation in other sections. Also, better solidity values can be set over the entire molded object, because, first, the quantity of second, softer plastic is less and, second, due to the homogeneous distribution at all points, identical mechanical and physical parameters are given.

Although any thermoplastic or optionally also duroplastic, which allows this use and with which the desired parameters can be set, can be used as the first matrix-forming and solidity-determining plastic, polyamide in particular lends itself to this use. Also, as the second sliding plastic, any plastic can be used, which can be processed also like the first plastic preferably in an injection molding process and to which the desired properties are imparted, wherein here PTFE is to be preferred.

In addition to the sliding or friction element itself, the invention further relates to a method for producing such an arbitrarily constructed sliding or friction element, e.g., in the form of a power transmission means guide. This method is distinguished in that for producing the section preferably in an injection molding method, a granulate is used made from at least two different plastics that are mixed together, of which the first plastic forms a plastic matrix, in which the second plastic acting as the sliding material is chemically bonded, wherein PA and PTFE are preferably used as the plastics.

### BRIEF DESCRIPTION OF THE DRAWINGS

Additional advantages and details of the invention emerge from the embodiment described below with reference to the figures. The figures are schematic representations and show:

FIG. 1 a cross-sectional view through a sliding or friction element in the form of a power transmission means guide, constructed as a slide rail, according to the state of the art immediately after production in an injection molding process, and

FIG. 2 a cross-sectional view through a sliding or friction element according to the invention in the form of a power transmission means guide, constructed as a slide rail, immediately after production in an injection molding process.

### DETAILED DESCRIPTION OF THE PREFERRED EMBODIMENTS

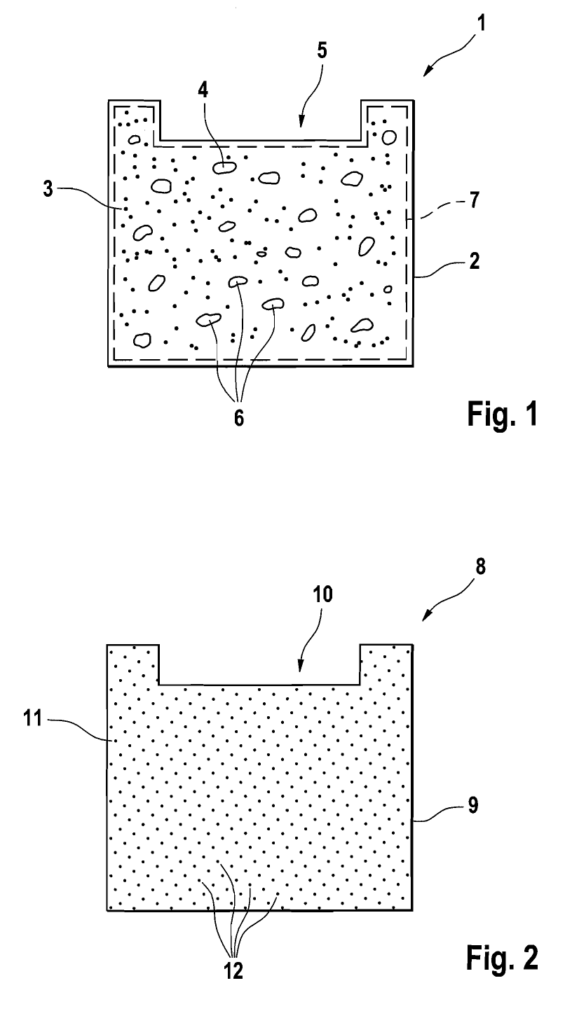

FIG. 1 shows a power transmission means guide 1 in the form of a slide rail 2 according to the state of the art. The slide rail is shown in section, because this depends on the distribution of the different types of plastic in cross section. Otherwise the slide rail 2 involves a typical slide rail that is customary in the art.

The slide rail 2 according to the state of the art is comprised of a first plastic 3, for example PA, and a second plastic 4, for example PTFE. On its top side it has an elongated, laterally limited recess or section 5, on which, for example, a chain runs.

The slide rail 2 was produced in an injection molding process. It is visible that the distribution of the two plastics 3 and 4 is inhomogeneous over the cross-sectional area. In the plastic 3, which is in abundance and essentially determines the solidity properties of the slide rail 2, the second plastic 4 is bound, but not in a homogeneous distribution, but instead a plurality of islands 6 of high concentration of PTFE or comprised of pure PTFE is formed as shown in the schematic diagram. In addition, as shown in FIG. 1, an outer molded skin 7 is formed, which results from the injection molding process and in which there is absolutely no PTFE due to segregating effects.

From this molded skin 7 and the inhomogeneous PTFE distribution there result, first, problems during startup, because a stick-slip effect is generated at this point, and second, the inhomogeneously distributed PTFE is rubbed off due to the chain contact, so that a tribologically optimal sliding layer is not set.

In contrast, FIG. 2 shows a power transmission means guide 8 according to the invention in the form of a slide rail 9, which is likewise shown in section and has a section 10 that contacts a chain that is not shown in more detail. The slide rail 9 is also comprised of a first plastic 11, preferably PA, and a second plastic 12, preferably PTFE, which here, as should be shown in the schematic diagram, is distributed absolutely homogeneously, because it is embedded in a plastic matrix formed from a first PA plastic, which cannot be seen in the drawing. This means that the PTFE molecular chains are distributed on the molecular level and chemically bonded to the PA molecular chains. This leads to a homogeneous distribution and homogeneous solidity properties over the tensioner cross section, so that the section 10 has homogeneous, constant sliding properties at every instance. Due to the chemical bonding and homogeneous distribution, it is no longer possible that the PTFE will be rubbed out. A tribologically optimal sliding layer is formed, which provides PTFE as a sliding material at the surface even at the beginning, so that run-in effects are no longer produced, which could have disadvantageous effects.

In addition to the power transmission means guides described in the figures, a sliding or friction element according to the invention can also be realized, for example, in the form of a slide bushing or a pivoting or sliding bearing or as a support that can be attached to a third object, e.g., a guide rail or the like. There, each section produced from the plastic granulate used according to the invention is also exposed to mechanical loads, which are absorbed significantly better than compared with previously known sections, while avoiding the disadvantages described above.

### REFERENCE NUMBERS

1 Power transmission means guide
2 Slide rail
3 Plastic
4 Plastic
5 Section
6 Island
7 Molded skin
8 Power transmission means guide
9 Slide rail
10 Section
11 Plastic
12 Plastic

1. Sliding or friction element that can be mechanically loaded, comprising a section, which can be mechanically loaded and which is formed of at least first and second different plastics, of which one is used as a sliding material, the first plastic forms a plastic matrix, in which the second plastic is chemically bonded.

2. Sliding or friction element according to claim 1, the second plastic is PTFE.

3. Sliding or friction element according to claim 1, the first plastic is PA.

4. Sliding or friction element according to claim 1, wherein fiber reinforcement is integrated in the section.

5. A Method for producing a sliding or friction element having a section that can be mechanically loaded that is formed from at least first and second different plastics, comprising using a granulate for producing at least the section in an injection molding process, with the first plastic forming a plastic matrix, in which the second plastic acting as a sliding material is chemically bonded.

6. Method according to claim 5, wherein the first plastic is PA and the second plastic is PTFE.
